(19) United States
(12) Patent Application Publication
(10) Pub. No.: US 2025/0121638 A1
(43) Pub. Date: Apr. 17, 2025

(54) ENGAGEABLE TOW HOOK ASSEMBLIES AND VEHICLES INCLUDING SAME

(71) Applicant: TOYOTA MOTOR NORTH AMERICA, INC., Plano, TX (US)

(72) Inventor: Jeffrey C. Souder, Frisco, TX (US)

(73) Assignees: TOYOTA MOTOR NORTH AMERICA, INC., Plano, TX (US); TOYOTA JIDOSHA KABUSHIKI KAISHA, Toyota-shi (JP)

(21) Appl. No.: 18/380,443

(22) Filed: Oct. 16, 2023

(51) Int. Cl. B60D 1/04; B60D 1/52

(52) U.S. Cl. CPC B60D 1/04; B60D 1/52

(57) ABSTRACT

A tow hook assembly includes a receiving member and a clevis pin. The clevis pin has a bolt portion formed by a number of equidistant edges. Each pair of adjacent edges define an interior side wall that extends between the pair of adjacent edges. The interior side wall is recessed with respect to the edges. The bolt portion is configured such that the edges engage with a vehicle lug nut wrench.

### TECHNICAL FIELD

The present specification generally relates to tow hook assemblies for vehicles and, more specifically, a tow hook assembly configured to be engageable with a vehicle lug nut wrench.

### BACKGROUND

To tow a vehicle in the event of an accident, malfunction, loss of gas, or being stuck in mud or snow, tow hooks are provided at specific locations of a frame of the vehicle to tow the vehicle without causing damage. Tow hooks are typically mounted on a front rail of the vehicle and may extend through apertures formed in a front bumper of the vehicle to project outwardly therefrom. Alternatively, tow hooks may project from beneath the front bumper or any other suitable location around the vehicle, for example, a rear of the vehicle.

Tow hooks are typically formed from a rigid material to withstand large forces when being towed and to remain secured to the vehicle itself. However, during use, a tow hook assembly may need adjustments to provide clearance for a hook or strap. However, drivers may find the need to keep a separate wrench in the vehicle solely for adjusting the tow hooks dissatisfying. Additionally, the tow hooks may be unseemly or unattractive to the owner of the vehicle.

Accordingly, a need exists for an improved tow hook assembly that engages with an existing vehicle lug nut wrench that is provided in the vehicle for adjusting the tow hooks for maneuverability or detachability.

### SUMMARY

In one embodiment, a vehicle includes a tow hook assembly. The tow hook assembly includes a tow hook and a clevis pin. The clevis pin has a bolt head portion formed by a number of equidistant edges. Each pair of adjacent edges define an interior side wall that extends between the pair of adjacent edges. The interior side wall is recessed with respect to the edges. The bolt portion is configured such that the edges engage with a vehicle lug nut wrench.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a vehicle including a pair of tow hook assemblies and vehicle lug nut wrench, according to one or more embodiments shown and described herein;

FIG. 2 schematically depicts an exploded view of a tow hook assembly including a clevis pin, according to one or more embodiments shown and described herein; and

FIG. 3 schematically depicts a side view of the tow hook assembly of FIG. 2, according to one or more embodiments shown and described herein.

### DETAILED DESCRIPTION

Embodiments described herein are directed to tow hook assemblies that include a receiving member with a clevis pin with an engageable bolt end to allow for an adjustable or detachable tow hook assembly with a vehicle lug nut wrench. The bolt end includes a number of equidistant edges with adjacent edges that define an interior side wall extending between each pair of adjacent edges. The edges and interior side walls of the bolt end are configured such that the edges engage with the vehicle lug nut wrench. The lug nut wrench rotates the clevis pin to disengage or engage the clevis pin with the receiving member. The various components of the tow hook assemblies disclosed herein may be positioned such that the tow hook may be adjustable or decouple from the vehicle upon movement or disengagement of the clevis pin of the receiving member.

Various embodiments of the tow hook assemblies and operation of the tow hook assemblies are described in more detail herein. Whenever possible, the same reference numerals will be used throughout the drawings to refer to the same or like parts.

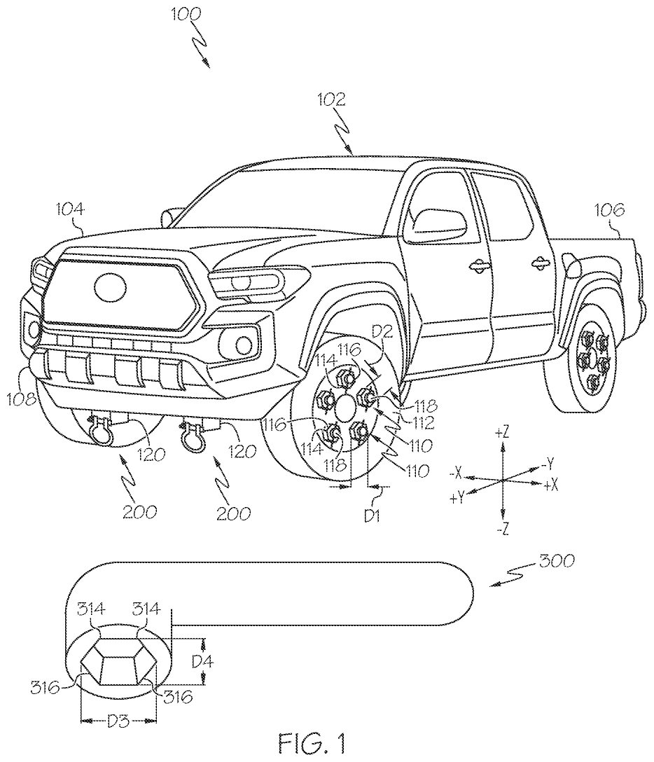

As used herein, the term “vehicle longitudinal direction” refers to the forward-rearward direction of the vehicle (i.e., in the +/− Y direction of the coordinate axes depicted in FIG. 1). The term “vehicle lateral direction” refers to the cross-vehicle direction (i.e., in the +/− X direction of the coordinate axes depicted in FIG. 1), and is transverse to the vehicle longitudinal direction. The term “vehicle vertical direction” refers to the upward-downward direction of the vehicle (i.e., in the +/− Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings.

Referring now to FIG. 1, a vehicle 100 is generally illustrated according to one or more embodiments described herein. As shown, the vehicle 100 is illustrated as a pickup truck. However, the vehicle 100 may be any suitable automobile including coupes, sedans, minivans, crossovers, hybrids, sports utility vehicles, or the like, in addition to other vehicles such as a bus, boat, or the like, without limiting the scope of the present disclosure. The vehicle 100 includes a body 102 having a front end 104, a rear end 106 opposite the front end 104, and a front bumper 108 provided at the front end 104 of the body 102 of the vehicle 100.

The vehicle 100 includes one or more tow hook assemblies 200 located at the front end 104 of the body 102 of the vehicle 100. For example, as depicted herein, the vehicle 100 includes a pair of tow hook assemblies 200 mounted to a frame 120 of the vehicle 100 as to extend below the front bumper 108 at the front end 104 of the vehicle 100. However, it should be appreciated that the vehicle 100 may include any number of tow hook assemblies 200, such as one tow hook assembly 200 or more than two tow hook assemblies 200. In addition, the tow hook assembly 200 may be mounted at any suitable location of the vehicle 100 such as, for example, though an opening in the front bumper 108, at the front end 104 of the vehicle 100, or to the frame 120 of the vehicle 100 located rearward of the front bumper 108 in the vehicle longitudinal direction of the vehicle 100.

Referring still to FIG. 1, the vehicle 100 includes one or more lug nuts 110 configured to fasten a wheel 112 of the vehicle 100 to a axle of the vehicle 100. The vehicle lug nuts 110 are tightened onto the wheel 112 by threaded studs 118. The lug nuts 110 have a generally hexagonal shape and have six equidistant edges 114 and six side walls 116 between adjacent edges 114. Although in the illustrated embodiment the lug nut 110 has six edges 114, it should be understood that in embodiments the lug nuts 110 may have any even number of edges 114.

The lug nut 110 has a distance D1 that extends between a pair of opposing edges 114. The pair of opposing edges 114 are positioned opposite each other such that a line connecting the pair of opposing edges 114 would bisect the lug nut 110 into two equal parts. The lug nut 110 also has a distance D2 that extents between a pair of opposing side walls 116.

In embodiments, the vehicle 100 includes a lug nut wrench 300 that is used to engage with the lug nut 110. The lug nut wrench 300 has a corresponding shape and size to the lug nut 110 of the vehicle 100. For example, the lug nut wrench 300 generally is of a shape corresponding with the same number of edges 114 and of the same diameter of the lug nut 110 of the vehicle 100. The lug nut wrench 300 has a cavity with the same number of edges 314 and sides 316 as the lug nut 110. Further, the lug nut wrench 300 has a distance D3 that extends between a pair of opposing edges 314. The lug nut wrench 300 has a distance D4 that extends between a pair of opposing sides 316. The distance D3 is slightly larger than the distance D1 of the lug nut 110 and the distance D4 is slightly larger than the distance D2 of the lug nut 110. As such, the lug nut wrench can receive and engage the lug nut 110. Upon engagement with the lug nut wrench, the lug nut 110 is tightened or loosened from the wheel 112 of the vehicle 100.

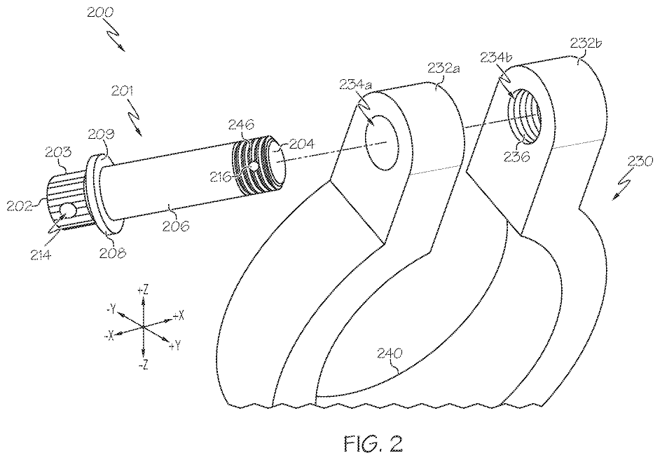

Referring now to FIG. 2, an exploded perspective view of the tow hook assembly 200 is depicted. The tow hook assembly 200 includes a tow hook 230 and a clevis pin 201. The tow hook 230 includes a first arm 232a, a second arm 232b, and a connection portion 240 that connects distal ends of the first arm 232a and the second arm 232b. In the illustrated embodiments, the tow hook 230 is in the form of a shackle. However, the tow hook 230 is not limited to the form of a shackle. In embodiments, the tow hook 230 is of a shape to allow a component outside the vehicle 100 to latch or hook to the connection portion 240 of the tow hook 230, for example, a general U shape or hook shape.

Openings 234a, 234b are formed in both the first arm 232a and the second arm 232b of the tow hook 230, respectively. In embodiments, the opening 234a of the first arm 232a is a through bore configured to allow the clevis pin 201 to move through, as described below. In embodiments, the opening 234b of the second arm 232b includes internal threads 236 configured to be an internally threaded bore and configured to engage with the threaded portion 246 of the clevis pin 201, as described below.

The clevis pin 201 has a substantially cylindrical shape with a bolt head end 202 and a threaded end 204 opposite the bolt head end 202. The clevis pin 201 has a shaft 206 extending between the bolt head end 202 and the threaded end 204. A threaded portion 246 extends partially onto the shaft 206 from the threaded end 204 and includes threads configured to fit into the internal threads 236 of the opening 234b of the second arm 232b of the tow hook 230. In some embodiments, a throughbore 216 extends through the threaded portion 246 of the clevis pin 201. In such embodiments, the throughbore 216 may be configured to fit a cotter pin, a hair pin, or any other securing member as to secure the clevis pin 201 to the tow hook 230.

The clevis pin 201 further includes a washer member 208 located between the shaft 206 of the clevis pin 201 and the bolt head end 202. The washer member 208 is generally circular in shape and extends outward from the shaft 206 of the clevis pin 201. The washer member 208 includes a first surface 209 configured to abut against the first arm 232a of the tow hook 230 to prevent the bolt head end 202 of the clevis pin 201 from entering the opening 234a of the first arm 232a of the tow hook 230.

The length of the clevis pin 201 is greater than a width of the tow hook 230 extending between an outer surface of the first arm 232a proximate the opening 234a and an outer surface of the second arm 232b proximate the opening 234b. Accordingly, the bolt end 202 and the threaded end 204 protrude outwardly from the openings 234a, 234b formed in the first arm 232a and the second arm 232b, respectively, when positioned within the tow hook 230.

The clevis pin 201 includes a bolt head portion 203 between the bolt head end 202 and the washer member 208. As described later, the edges 210 and interior side walls 212 extend from the bolt head end 202 to the washer member 208 to make up the bolt head portion 203. In embodiments, the bolt head portion 203 may include a bolt aperture 214 extending through the bolt head portion 203 of the clevis pin 201. The bolt aperture 214 is configured to extend an object through to generate greater torque when engaging with the bolt head portion 203 of the clevis pin 201, as described below.

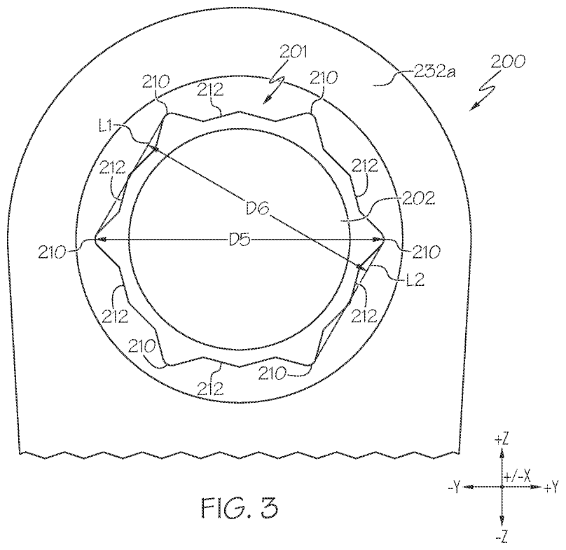

Referring now to FIG. 3, a side view of the tow hook assembly 200 is illustrated. The bolt head portion 203 of the clevis pin 201 includes a number of equidistant edges 210. In embodiments the number of edges 210 is six, however, it should be understood that there may be any number of equidistant edges 210. In such embodiments, the bolt head portion 203 of the clevis pin 201 is a generally hexagonal shape.

Each pair of adjacent edge 210 defines an interior side wall 212. The interior side wall 212 extends between the pair of adjacent edge 210 and is recessed with respect to the edges 210. In embodiments, the interior side wall 212 may be convex, concave or substantially straight in shape. In embodiments, the interior side wall 212 may be formed of two walls meeting at a central point or one curved wall.

The bolt head portion 203 has a distance D5 that extends between a pair of opposing edges 210. The bolt head portion 203 also has a distance D6 that extends between an imaginary line L1 that extends between a pair of adjacent edges 210, and an imaginary line L2, that extends between a pair of adjacent edges 210 on an opposite side of the bolt head portion 203. The distance D5 of the bolt head portion is substantially equal to the distance D1 of the lug nut 110. The distance D6 of the bolt head portion 203 is substantially equal to the distance D2 of the lug nut 110. As such, the vehicle lug nut wrench 300 can receive and engage the bolt head portion 203.

Referring to FIGS. 1, 2, and 3, the vehicle lug nut wrench 300 is configured to engage with the bolt head portion 203 of the clevis pin 201 to couple the clevis pin 201 with the tow hook 230. As an illustrative example, the vehicle lug nut 110 has six edges 114 and a distance D1 and distance D2 and the bolt head portion 203 of the clevis pin 201 has six edges 210 with a distance D5 and distance D6 equal to the distance D1 and distance D2, respectively. As the vehicle lug nut wrench 300 is configured to fit the lug nut 110 with a corresponding number of edges 114 and distance D1, the vehicle lug nut wrench 300 will engage with the bolt head portion 203 of the clevis pin 201.

The shaft 206 of the clevis pin 201 extends through the opening 234a of the first arm 232a and into the opening 234b of the second arm 232b to be received in the tow hook 230 such that the threaded portion 246 engages with the internal threads 236 of the opening 234b of the second arm 232b. The first surface 209 of the washer member 208 abuts the first arm 232a to prevent the clevis pin 201 from extending further through the opening 234a of the first arm 232a. The vehicle lug nut wrench engages with the bolt head end 202 of the clevis pin 201 to rotate the clevis pin 201 within the tow hook 230. The rotation of the clevis pin 201 causes the rotation of the threaded portion 246 within the internal threads 236 of the opening 234b of the second arm 232b, therefore tightening or loosening the clevis pin 201 within the tow hook 230. The tightening and loosening of the clevis pin 201 allows for adjustment or disengagement of the tow hook 230 with the vehicle 100. In embodiments, a member can be places through the bolt aperture 214 for additional torque.

From the above, it is to be appreciated that defined herein are embodiments of tow hook assemblies including a tow hook and a clevis pin having a bolt head portion configured to be engaged with a vehicle lug nut wrench. Permitting the tow hook assemblies described herein to rotate or detach provides necessary clearance for a hook or strap for use of the tow hook assembly.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle including a tow hook assembly, the tow hook assembly comprising:
a tow hook; and
a clevis pin having a bolt head portion formed by a number of equidistant edges, each pair of adjacent edges defining an interior side wall extending between the pair of adjacent edges and recessed with respect to the edges, the bolt head portion configured such that the edges engage a vehicle lug nut wrench.

2. The vehicle of claim 1, wherein the bolt head portion is has a first distance that extends between a pair of opposing edges.

3. The vehicle of claim 1, further comprising vehicle lug nuts each having a number of equidistant edges, each pair of adjacent edges defining side wall, each of the vehicle lug nuts having a first distance extending between a pair of opposing edges, the first distance of the bolt head portion is equal to the first distance of each of the vehicle lug nuts.

4. The vehicle of claim 1, wherein the clevis pin further comprises a threaded portion having opposite the bolt head portion, a shaft extending between the bolt head portion and the threaded portion, and a washer member between the shaft and the bolt head portion.

5. The vehicle of claim 4, wherein the tow hook includes a pair of arms and an opposing connection portion provided between the pair of arms.

6. The vehicle of claim 5, wherein the pair of arms comprises a first arm having a through bore and a second arm having an internally threaded bore, the threaded portion of the clevis pin configured to fit in the internally threaded bore.

7. The vehicle of claim 6, wherein upon engagement of the edges with the vehicle lug nut wrench, the clevis pin engages with the tow hook based on a fit between the internally threaded bore and the threaded portion of the clevis pin.

8. The vehicle of claim 4, wherein an aperture is formed in the bolt head portion of the clevis pin between a bolt end and the washer member.

9. The vehicle of claim 4, wherein an aperture is formed in the threaded portion of the clevis pin.

10. The vehicle of claim 3, further comprising a vehicle lug nut wrench having a number of equidistant edges, each pair of adjacent edges defining side wall, the vehicle lug nut wrench having a first distance extending between a pair of opposing edges, the first distance of the vehicle lug nut wrench corresponding to the first distance of each of the vehicle lug nuts.
